(19) United States
(12) Patent Application Publication
(10) Pub. No.: US 2026/0017517 A1
(43) Pub. Date: Jan. 15, 2026

(54) AUTOMATED FEATURE SELECTION FOR SPLIT NEURAL NETWORKS

(71) Applicant: Telefonaktiebolaget LM Ericsson (publ), Stockholm (SE)

(72) Inventors: Selim ICKIN, Danderyd (SE); Hannes LARSSON, Solna (SE); Konstantinos VANDIKAS, Solna (SE); Xiaoyu LAN, Täby (SE)

(73) Assignee: Telefonaktiebolaget LM Ericsson (publ), Stockholm (SE)

(21) Appl. No.: 18/871,229

(22) PCT Filed: Aug. 30, 2022
(86) PCT No.: PCT/EP2022/074002

§ 371 Date: Dec. 3, 2024

(30) Foreign Application Priority Data
Jun. 3, 2022 (GR) 20220100470

(51) Int. Cl. G06N 3/082; G06N 3/084

(52) U.S. Cl. CPC G06N 3/082; G06N 3/084

(57) ABSTRACT

A computer-implemented method and apparatus for feature selection using a distributed machine learning (ML) model in a network comprising a plurality of local computing devices and a central computing device is provided. The method includes training, at each local computing device, the ML model during one or more initial training rounds using a group of input features representing a input features layer of the ML model. The method further includes generating, at each local computing device, based on the one or more initial training rounds, feature group values. The method further includes transmitting, from each local computing device, to the central computing device, the generated feature group values. The method further includes receiving, at each local computing device, from the central computing device, central computing device gradients. The method further includes computing, at each local computing device, local computing device gradients, using the received central computing device gradients. The method further includes generating, at each local computing device, a gradient trajectory for each input feature in the group of input features based on the computed local computing device gradients. The method further includes identifying, at each local computing device, based on the generated gradient trajectory, whether each input feature in the group of input features is non-contributing. The method further includes removing, at each local computing device, from the group of input features representing the input features layer of the ML model, each input feature identified as non-contributing. The method further includes training, at each local computing device, the ML model during one or more continuing training rounds using the group of input features representing the input features layer of the ML model with each non-contributing input feature removed. The apparatus includes processing circuitry and a memory containing instructions executable by the processing circuitry, whereby the apparatus is operative to perform the method for feature selection using an ML model.

### TECHNICAL FIELD

Disclosed are embodiments related to feature selection using a distributed machine learning (ML) model in a network and, more particularly, to automate feature selection for split neural networks by identifying and removing non-contributing features.

### BACKGROUND

As more and more 5G telecommunications equipment is being deployed, there is a corresponding increase in the expectation of the marketplace for improved QoE (Quality of Experience) and greater energy-efficiency. As the complexity of telecommunication networks is also increasing, there is an increasing demand for automated and smart decision-making components to be used. As a result of the increased complexity of telecommunication networks and the need for denser deployments, there is a greater need for telecommunication networks to employ an edge computing paradigm in which processing power is more decentralized. This has the potential to reduce latency and also to protect data privacy, which may be required when parts of a network are owned and/or operated by different entities.

Different elements of a network, which may be controlled by different entities, may possess information that is important for training ML systems for controlling the overall network, as they may host different sensors and network performance measurement probes that accumulate observations of different aspects of the network, referred to herein as “orthogonal measurements.”

There are known ML techniques, such as Split Neural Networks (SplitNN), that enable training on orthogonal datasets (also known as split features), such as, for example, datasets that have non-overlapping or vertical feature space. Using a split neural network may reduce the bandwidth/throughput requirements of training a neural network (NN) using data collected from many different sources in exchange for added complexity of the ML system.

In telecommunication networks, the datasets that are used to train ML models are often inherently distributed, and might contain orthogonal but complementary QoE factors, i.e., ML features. A typical example is a QoE estimation use case in a heterogeneous and decentralized mobile network, when the core network has observations related to network throughput and delay; while the user end-device has access to application level metrics, such as stalling events, playout bitrate, and even user ratings, e.g., Mean Opinion Scores (MOS). Privacy protection and reduced data transfer costs are important requirements in ML training. Therefore, training a ML model on many inherently decentralized entities without sharing raw data necessitates collaborative learning techniques, such as Split Learning (SL). See, Maarten G. Poirot. et. al., “Split Learning for collaborative deep learning in healthcare,” 33rd Conference on Neural Information Processing Systems (NeurIPS 2019), Vancouver, Canada; and Ickin, S.; Fiedler, M.; Vandikas, K., “QoE Modeling on Split Features with Distributed Deep Learning,” Network 2021, 1(2), pp. 165-190.

In a SplitNN, for example, the local computing devices, e.g., workers, can have orthogonal or overlapping input features, X, without having the labels, y. A typical use case for this is when a local computing device, such as an actuator module, has access only to partial observations and does not know the consequences of its actions. For example, a partial observation and actuation in the core network, where the label is obtained in a User Equipment (UE) or at a third party. The labels can exist on another computation node, for example, a central computing device, such as a Parameter Server (PS).

Samples, such as, for example, data sets including input features at different nodes do not need to be communicated in between. Samples can be aggregated values per time interval, e.g., average KPI between 1 PM and 2 PM. The nodes only negotiate on the time interval. The central computing device, such as a driver, tells all the local computing devices, such as workers, to train on their ML models on a data set at a given time interval. Then, a ML model is trained collaboratively (on the instructed data aggregation time interval), where the local computing devices perform a forward pass and can encode the input features into a compressed representation, where this representation is sent to a central computing device, such as the PS, over the interface (or so-called cut) layer. The PS concatenates the received encoded representation; [DX1, DX2, . . . , DXN]. The PS continues the computation with a forward pass. At the last layer of the PS, the error is computed since the PS has the labels. Based on the error, the gradients are calculated via a backwards propagation via a chain-rule partial derivative and the weights are updated with the calculated gradients until the first layer of the PS. The PS splits the gradients in the same way the concatenation was done earlier (upon reception of logits from workers). [GW1, GW2, . . . , GWN]: G is gradient at the first layer of the PS, GWN is the split gradient of worker N. The PS is agnostic to the input features and can access only the latent form of the input attributes that are the output at the interface layer of the local computation nodes (workers). These gradients and encoded values often allocated to a fixed amount of space in memory as all are floating points regardless of the information they carry.

SplitNNs require a compressed representation of data to be sent from a local node to a central node, such as a Parameter Server (PS), until ML model convergence. With large input data sets, the number of required iterations can get very high. See X. Liu, J. Zhao, J. Li, B. Cao and Z. Lv, “Federated Neural Architecture Search for Medical Data Security,” in IEEE Transactions on Industrial Informatics, vol. 18, no. 8, pp. 5628-5636 August 2022, doi: 10.1109/TII.2022.3144016. Further, the encoded data matrix represented in the compressed representation at the cut layer of every local computing device neural network does not always contain information that is useful during training. The interfacing cut layer is often kept constant during training regardless of the information being transferred, hence yielding unnecessary communication cost. It, in parallel, increases the computation cost on both local worker nodes and central PS, since the values need to be computed for these existing neurons.

### SUMMARY

Identifying feature importance in a decentralized setting is very difficult because local computing devices may only have access to the input features and not to the ground truth labels—e.g., the actual nature of the problem that is the target of a ML model, reflected by the relevant data sets associated with the use case in question. At the same time, failing to detect non-contributing features causes increased computation overhead, latency, and network footprint during training. Accordingly, a robust framework which can be applied to ML models is used, for example, in telecommunications, such as SplitNNs, to help reduce unnecessary computation overhead at the local computer nodes, minimize latency, and reduce network footprint during training is desirable.

In the literature, the network footprint is only reduced via parameter compression or by quantization techniques at the neural network layers. See, e.g., Ickin, S., Fiedler, M., Vandikas, K., QoE Modeling on Split Features with Distributed Deep Learning. Network 2021, 1, 165-190.

Other feature group selection algorithms exist in the art that can be used to automatically detect a non-contributing feature group. The feature group selection algorithms already known in the art require a separate algorithm to be deployed on the central computing device. Because the central computing device is agnostic to the input features, these feature group selection algorithms might not be granular especially in cases when there are both contributing and non-contributing features in the same feature group.

There are also already existing feature importance calculator techniques, such as permutation importance, LIME, and Shapley Additive explanations (SHAP). Additionally, saliency maps are known in the art and are used on gradients of trained neural networks to reveal what part of the images contributes to a model decision. However, none of the existing work takes into account the gradient trajectory during training. Instead, all of the techniques known in the art consider the gradients only after training. However, detecting features after training is too late, since the training would have already allocated resources (i.e., computation, memory, and network footprint).

Further, using a saliency map is incompatible in a SplitNN because saliency map creation requires that the data labels be present. On the other hand, in a SplitNN setting, the local computing devices only have access to the input features, and not the labels.

In comparison to other feature detection techniques, embodiments disclosed herein detect the significance of an input feature as early as possible using individual gradient trajectories for each feature during training, whereas the other approaches in the art consider the gradient trajectories only after training.

Identifying non-contributing features during training allows for the removal of the non-contributing input features from the ML model, such as, for example, a SplitNN, during training. Reducing the number of input features as well as interface (or cut) layer neuron counts reduces the training time, computation cost, and the network footprint during an early phase of training. These improvements make it easier and faster to troubleshoot the ML model.

Some of the embodiments disclosed herein address the drawbacks associated with the current approaches by providing a novel feature detection method in using a ML model, such as, for example, a SplitNN, to detect non-contributing features during training. In some embodiments, the method and apparatus utilize a pre-trained ML model to detect non-contributing features. In other embodiments, the method and apparatus use traditional statistical analysis to detect non-contributing features.

Some of the embodiments of the disclosed feature selection method and apparatus use gradient trajectories for each of the input features to detect non-contributing features. Some of the embodiments of the disclosed feature selection method and apparatus enable faster interpretability and troubleshooting in the case of an unexpected outcome.

In a first aspect, a computer-implemented method for feature selection using a distributed machine learning (ML) model in a network comprising a plurality of local computing devices and a central computing device is provided. The method includes training, at each local computing device, the ML model during one or more initial training rounds using a group of input features representing a input features layer of the ML model. The method further includes generating, at each local computing device, based on the one or more initial training rounds, feature group values. The method further includes transmitting, from each local computing device, to the central computing device, the generated feature group values. The method further includes receiving, at each local computing device, from the central computing device, central computing device gradients. The method further includes computing, at each local computing device, local computing device gradients, using the received central computing device gradients. The method further includes generating, at each local computing device, a gradient trajectory for each input feature in the group of input features based on the computed local computing device gradients. The method further includes identifying, at each local computing device, based on the generated gradient trajectory, whether each input feature in the group of input features is non-contributing. The method further includes removing, at each local computing device, from the group of input features representing the input features layer of the ML model, each input feature identified as non-contributing. The method further includes training, at each local computing device, the ML model during one or more continuing training rounds using the group of input features representing the input features layer of the ML model with each non-contributing input feature removed.

In some embodiments, the local interface layer of the ML model includes a plurality of neurons and the one or more training, at each local computing device, the ML model during one or more continuing training rounds using the group of input features representing the input features layer of the ML model with each non-contributing input feature removed includes removing, at each local computing device, from the local interface layer of the ML model, one or more neurons based on the removed quantity of non-contributing input features.

In some embodiments, the steps of the method are performed until one or more conditions are satisfied: the ML model reaches convergence; a loss value computed for the ML model is less than a prespecified threshold loss value; or a performance metric reaches a prespecified performance metric value.

In some embodiments, the ML model is a split neural network (SplitNN), the input features layers and local interface layers include neurons, the local interface layers are cut layers, and the removing step includes, at each local computing device, one or more of: pruning from one or more of the input features layers or the local interface layers of the ML model, one or more neurons based on the removed quantity of non-contributing input features; or reshaping one or more of the input features layers or the local interface layers of the ML model to exclude one or more neurons based on the removed quantity of non-contributing features.

In some embodiments, the group of input features at one local computing device is orthogonal to the group of input features at the other local computing devices or non-orthogonal to the group of input features at the other local computing devices. In some embodiments, the generated feature group values are encoded. In some embodiments the generated feature group values are represented at a local interface layer of the ML model.

In some embodiments, the number of pruned neurons in the local interface layers is proportionate to the number of removed non-contributing input features. In some embodiments the local computing devices are one or more of: worker nodes, user equipment (UE), eNodeB (eNB), gNodeB (gNB), packet data network gateway (PGW), serving gateway (SGW), Internet of Thing (IoT) devices, or actuator modules. In some embodiments the central computing device is one or more of: a parameter server (PS), a master node, a driver node, or an application server.

In some embodiments, the step of identifying whether each input feature in the group of input features is non-contributing further comprises applying a pre-trained ML model to the generated gradient trajectory to determine whether a given input feature is non-contributing.

In some embodiments, the step of identifying whether each input feature in the group of input features is non-contributing further comprises: applying conventional statistical analysis to the generated gradient trajectory to determine whether a given input feature is non-contributing.

In some embodiments, the gradients corresponding to each input feature in the group of input features are computed based on loss values, said loss values being representative of errors based on differences between ground truth labels and predicted or estimated values for the labels. In some embodiments, the gradient trajectory for each input feature in the group of input features corresponds to a time series form of mean absolute gradient per input feature per layer at every round.

In some embodiments, the step of training, at each local computing device, the ML model during one or more initial training rounds includes performing forward propagation training of the ML model using the group of input features. In some embodiments the step of generating, at each local computing device, the gradient trajectory for each input feature in the group of input features based on the computed local computing device gradients includes performing backward propagation training of the ML model using the computed local computing device gradients.

In some embodiments, the group of input features corresponds to one or more of: Quality of Experience (QoE) factors or Quality of Service (QOS) parameters. In some embodiments, the network is one or more of: a core network, a radio access network (RAN), or an open radio access network (O-RAN).

According to a second aspect, a computer-implemented method for feature selection using a distributed machine learning (ML) model in a network comprising a plurality of local computing devices and a central computing device is provided. The method includes receiving, at the central computing device, from each of the plurality of local computing devices, feature group values. The method further includes training, at the central computing device, the ML model using the received feature group values. The method further includes calculating, at the central computing device, gradients for the feature group values. The method further includes updating, at the central computing device, the ML model using the calculated gradients. The method further includes splitting, at the central computing device, the calculated gradients into groups, each group associated with one of the local computing devices and each calculated gradient in each group representing a neuron in a central interface layer. The method further includes transmitting, to the associated local computing devices, the group of calculated gradients representing the central interface layer.

In some embodiments, the method further includes receiving, at the central computing device, updated feature group values from each of the plurality of local computing devices, and using the updated feature group values for further training of the ML model.

In some embodiments, the central interface layer includes one or more neurons and the method further includes computing, at the central computing device, an updated count of the number of neurons in the local interface layers of the ML model at the plurality of computing devices, and reshaping, at the central computing device, the central interface layer based on the computed updated count.

In some embodiments, the ML model is a split neural network (SplitNN), the ML model includes an output layer, the central interface layer and the output layer include neurons with associated weights, the central interface layer is a cut layer, and updating the ML model using the calculated gradients includes updating the associated weights of the neurons using the calculated gradients.

In some embodiments, the method further includes computing, at the central computing device, loss values at an output layer of the ML model, and the step of training, at the central computing device, the ML model using the feature group values includes concatenating the received feature group values, performing forward propagation training of the ML model using the concatenated feature group values, and performing backward propagation training of the ML model using the computed loss values.

According to a third aspect, a local computing device for feature selection using a distributed machine learning (ML) model in a network comprising a plurality of local computing devices and a central computing device is provided. The local computing device includes a memory and a processor coupled to the memory. The processor is configured to train, at each local computing device, the ML model during one or more initial training rounds using a group of input features representing a input features layer of the ML model. The processor is further configured to generate, at each local computing device, based on the one or more initial training rounds, feature group values. The processor is further configured to transmit, from each local computing device, to the central computing device, the generated feature group values. The processor is further configured to receive, at each local computing device, from the central computing device, central computing device gradients. The processor is further configured to compute, at each local computing device, local computing device gradients, using the received central computing device gradients. The processor is further configured to generate, at each local computing device, a gradient trajectory for each input feature in the group of input features based on the computed local computing device gradients. The processor is further configured to identify, at each local computing device, based on the generated gradient trajectory, whether each input feature in the group of input features is non-contributing. The processor is further configured to remove, at each local computing device, from the group of input features representing the input features layer of the ML model, each input feature identified as non-contributing. The processor is further configured to train, at each local computing device, the ML model during one or more continuing training rounds using the group of input features representing the input features layer of the ML model with each non-contributing input feature removed.

According to a fourth aspect, a central computing device for feature selection using a distributed machine learning (ML) model in a network comprising a plurality of local computing devices is provided. The central computing device includes a memory and a processor coupled to the memory. The processor is configured to receive, at the central computing device, from each of the plurality of local computing devices, feature group values. The processor is further configured to train, at the central computing device, the ML model using the received feature group values. The processor is further configured to calculate, at the central computing device, gradients for the feature group values. The processor is further configured to update, at the central computing device, the ML model using the calculated gradients. The processor is further configured to split, at the central computing device, the calculated gradients into groups, each group associated with one of the local computing devices and each calculated gradient in each group representing a neuron in a central interface layer. The processor is further configured to transmit, to the associated local computing devices, the group of calculated gradients representing the central interface layer.

According to a fifth aspect, an apparatus is provided. The apparatus includes processing circuitry and a memory containing instructions executable by the processing circuitry that causes the apparatus to perform the method of any one of the embodiments of the first aspect or the second aspect.

According to a sixth aspect a computer program is provided. The computer program includes instructions for adapting an apparatus to perform the method of any one of the embodiments of the first aspect or the second aspect.

According to a seventh aspect, a carrier containing a computer program that includes instructions for adapting an apparatus to perform the method of any one of the embodiments of the first aspect or the second aspect is provided. In some embodiments, the carrier is one of an electronic signal, optical signal, radio signal, or computer readable storage medium.

### BRIEF DESCRIPTION OF THE DRAWINGS

The accompanying drawings, which are incorporated herein and form part of the specification, illustrate various embodiments.

FIG. 1 is block diagram illustrating a distributed neural network (NN) model.

FIG. 2 is a block diagram illustrating the local computing devices in a distributed NN.

FIG. 3 is a signal flow diagram illustrating signal flow according to an embodiment.

FIG. 4 is a signal flow diagram illustrating signal flow according to an embodiment.

FIG. 5 is a flow chart illustrating a process according to an embodiment.

FIG. 6 is a flow chart illustrating a process according to an embodiment.

FIG. 7 is a block diagram illustrating a network including a central computing device and a plurality of local computing devices according to an embodiment.

FIG. 8 is a block diagram illustrating an apparatus according to an embodiment.

FIG. 9 is a block diagram illustrating an apparatus according to an embodiment.

### DETAILED DESCRIPTION

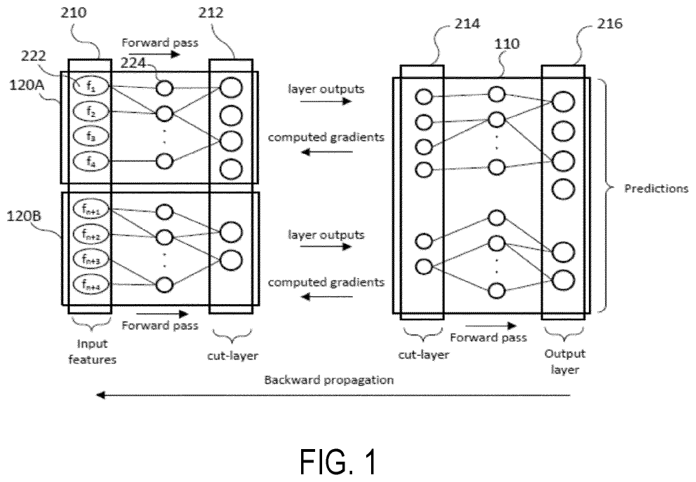

As shown in FIG. 1, local computing device 120A collects data relating to input features f1 to f4, while local computing device 120B collects data relating to input features fn+1 to fn+4. Each local computing device 120A, 120B has orthogonal and different input features than the other.

In addition to the input layer 210, each local computing device 120A, 120B may host zero or more other layers of the ML model, such as a NN, including intermediate layers 224 and an interface (or cut) layer 212, that faces the central computing device 110. The central computing device 110 hosts the remaining layers, interface (or cut) layer 214 and output layer 216 of the NN, in which the cut-layer 214 faces the local computing device 120A, 120B.

When the NN is being trained, the local computing devices 120A, 120B process input data corresponding to the features using the one or more NN layers and transmit the resulting values output by their last layer up to the central computing device 110. The central computing device 110 computes gradients of the NN neurons and transmits the gradients back down to the local computing devices 120A, 120B. As noted above, the layers 212, 214 at which the NN is separated between the local computing device 120A, 120B and the central computing device 110 are referred to as the “intermediate layers” or “cut-layers.”

A distributed NN can be jointly trained by combining the outputs of intermediate layers at the central computing device 110. Each local computing device 120A, 120B performs a forward-pass on multiple neural network layers at every local computing device node until its final layer. A forward-pass may include a cascaded form of linear transformations which are done via matrix multiplication of outputs of the neurons of the previous layers with the neuron weights, followed by a non-linear transformation (e.g., ReLu).

Since the training labels are not known for the local computing device 120A, 120B, an error computation is done at the central computing device 110. Therefore, the outputs of the last layer of the NN models at every local computing device 120A, 120B are sent over a communication channel to the central computing device 110 where they are further concatenated and connected to the first layer of the central computing device 110.

The forward-pass (cascaded linear and non-linear transformations) continues until the last layer 216 of the central computing device 110. The last layer, output layer 216, of the central computing device 110 contains the neuron(s) that output the final predicted/estimated values. The output is compared with ground truth labels, and an error computation is performed. Based on the error computation on every sample for which the forward pass was performed, the gradients at every neuron are computed, and the weights (i.e., the coefficient matrix of the neurons) are then adjusted to minimize/reduce the prediction/estimation error.

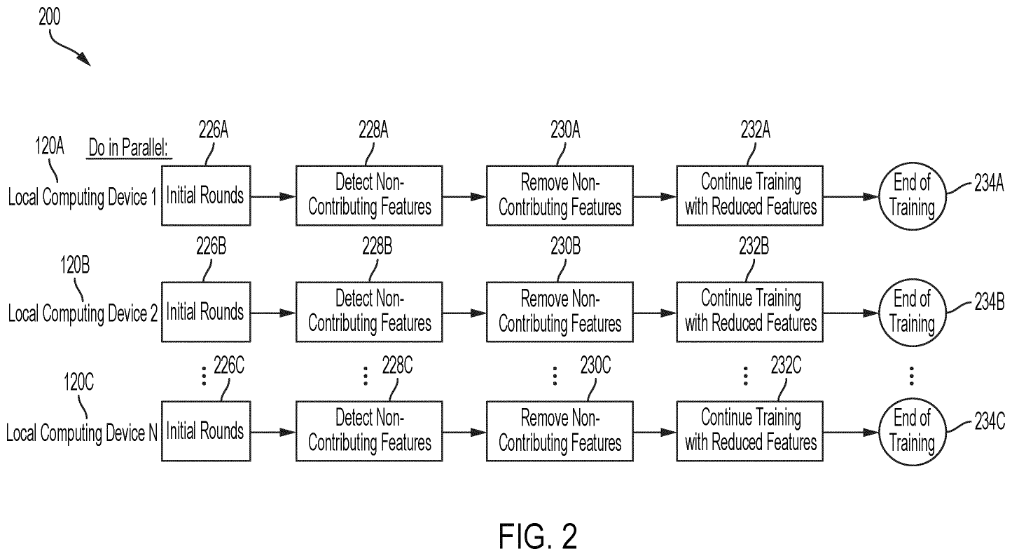

The central computing device 110 updates the weights until the first layer 214 (which is the interface cut-layer), and then the gradients are passed back to each local computing device 120A, 120B after splitting the gradients to each local computing device 120A, 120B. Note that in the example shown in FIG. 2, the two local computing devices 120A, 120B receive only the gradients associated with their neurons. After the local computing devices 120A, 120B receive their gradients, they continue with back-propagation on the local neurons layer-by-layer in the reverse direction until the first layer. Once the neuron weights are updated, the first round of training is complete. After sufficient iterations back and forth between the local computing device 120A, 120B and the central computing device 110, the NN model reaches convergence and is ready to be used as an inference engine.

FIG. 2 is a block diagram illustrating the local computing devices in a feature selection method during training in a distributed machine learning model. As shown in FIG. 2, each local computing device 120A, 120B, 120C performs initial rounds of training 226A, 226B, 226C, detects non-contributing features 228A, 228B, 228C, removes non-contributing features 230A, 230B, 230C, continues training with the reduced features 232A, 232B, 232C, and ends training 234A, 234B, 234C in parallel.

A local computing device 120A, 120B, 120C is also referred to herein as a worker node, a local node, or a feature group.

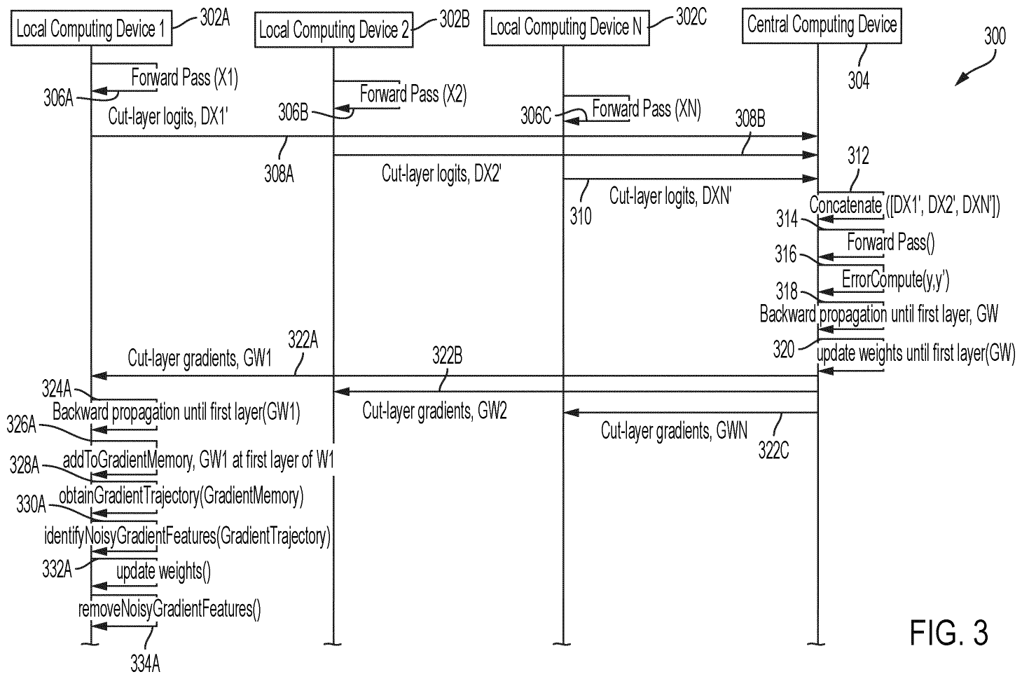

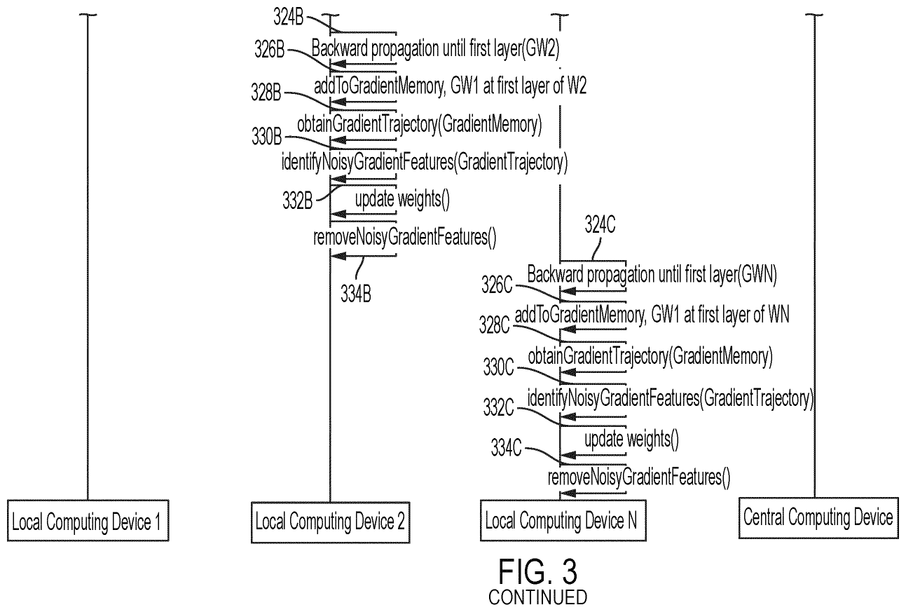

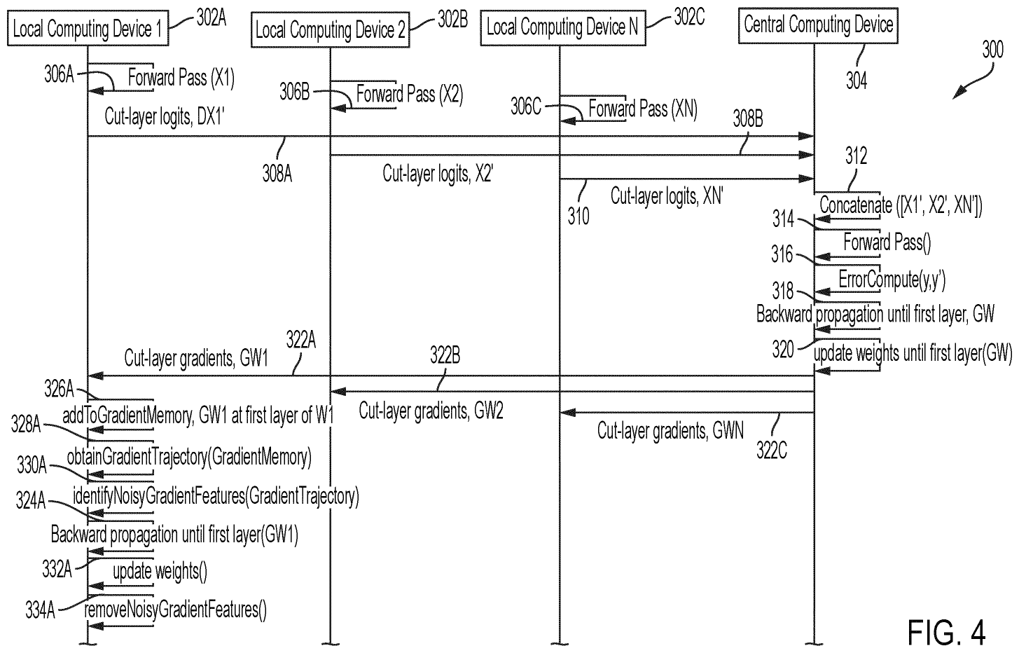

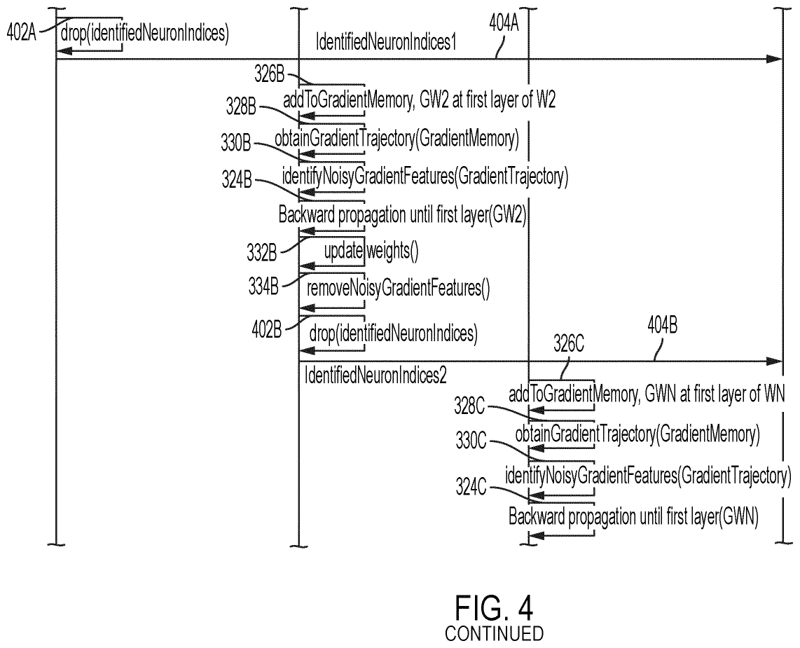

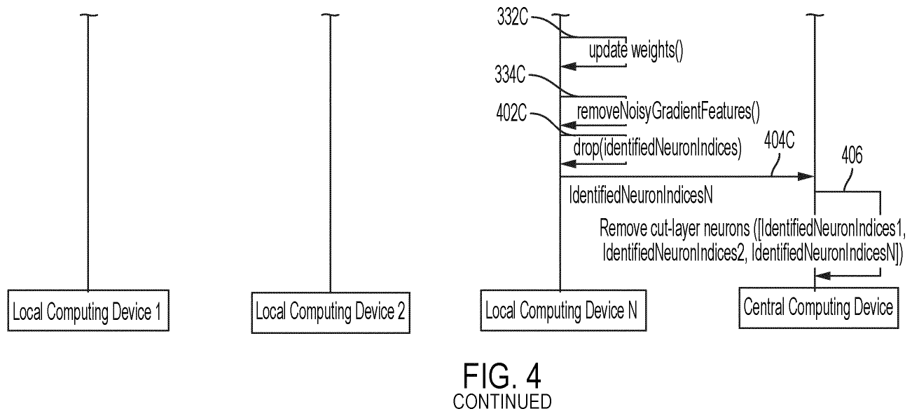

Steps 226-234 are depicted in further detail in FIG. 3 and FIG. 4.

FIG. 3 is a signal flow diagram illustrating signal flow according to an embodiment. The signal flow illustrated in FIG. 3 is between a central computing device 304 and a plurality of local computing devices 302A, 302B, 302C, for adapting the input layer neuron count. As shown in FIG. 3, the central computing device 304 relies for its operation on receiving layer values from local computing devices 302A, 302B, 302C, while the local computing devices 302A, 302B, 302C rely for their operation on receiving gradient values from the central computing device 304. The local computing devices 302A, 302B, 302C perform a forward pass 306A, 306B, 306C on the input features and encode the input features into a compressed representation. The compressed representation is transmitted 308A, 308B, 308C to the central computing device 304.

The central computing device 304 is also referred to herein as a master node, a central node, or a parameter server.

The central computing device 304 has access to the ground truth labels. In some embodiments, the ground truth labels relate to telecommunications. In some embodiments, the ground truth labels are Mean Opinion Score values (MOS values).

In some embodiments, each local computing device 302A, 302B, 302C in the network has orthogonal or overlapping input features, X, without having labels, y. Unlike the central computing device 304, a local computing device 302A, 302B, 302C only has access to partial observation and does not see the consequence of its actions because it does not have access to the ground truth labels.

The size of the NN model is highly related to the number of input features. Networks with more input parameters require more memory allocation during training. For example, a network with 8 parameters will require less memory allocation than a network with 20 parameters. It may be appreciated that the more input features in a NN model correspond to increased training time in the NN.

A local computing device 302A, 302B, 302C can be deployed at any network element that benefits from collaborative learning, including RAN, core network, application server, end UE or Iot device (or any terminal including vehicles and robots).

Input features are collected at a local computing device 302A, 302B, 302C. The input features collected at a given local computing device 302A, 302B, 302C do not need to be communicated to the other local computing devices 302A, 302B, 302C. In some embodiments, the collected input features are aggregated values over a given time interval. For example, in some embodiments the input features can be an average key performance indicator (KPI) from 1:00 pm to 2:00 pm. In some embodiments, the KPI relates to quality of service (QOS). In some embodiments, the KPI relates to quality of reception (QoR).

The NN for a local input device 302A, 302B, 302C consists of a matrix of dimensions N_{features}×N_{nextlayer}. For example, if the local input device 302A, 302B, 302C has 8 features and the next layer has 64 neurons, the gradient matrix would be 8×64 in the first layer since every feature is connected to 64 neurons, and every connection is associated with a neural weight.

The central computing device 304 concatenates 312 the encoded representation (logits) received from the local computing devices 302A, 302B, 302C: [D_{X1}, D_{X2}, . . . , D_{XN}]□D_{X}.

After concatenating 312 the encoded representation (logits), the central computing device 304 performs a forward pass 314 to obtain the final output. Next, the central computing device 304 computes the resulting error 316 using the ground truth labels.

After computing the resulting error 316, the central computing device 304 then performs back-propagation 318 of the resulting error to compute new gradients. The weights are then updated 320 with the calculated gradients until the first neuron layer of the central computing device 304. Specifically, in some embodiments gradients are calculated via a back-propagation via a chain-rule partial derivative.

The central computing device 304 splits the gradients and transmits the split gradients 322A, 322B, 322C to the respective local computing device 302A, 302B, 302C in the same way the concatenation was done earlier (upon reception of logits from the local computing devices). The gradients are split as follows: G_{W} à[G_{W1}, G_{W2}, . . . , G_{WN}]: G is gradient at the first layer of the central computing device (304), and G_{WN} is the split gradient of local computing device N 302C.

After receiving its respective group of gradients, the local computing devices 302A, 302B, 302C perform back-propagation 324A, 324B, 324C using the received gradients to correct the neuron weights.

After performing back-propagation 324A, 324B, 324C, the local computing devices 302A, 302B, 302C average the gradients received from the central computing device 304 for each input feature. The gradients may be averaged by the following equation: client_grad_mean=client_first_layer_gradients.T.mean(axis=1).reshape(−1,1).

Next, the mean gradients are then added to the gradient memory 326A, 326B, 326C by the following equation: gradient_memory.append(list(np.squeeze(client_grad_mean))).

Steps 302-320 are repeated for a predefined number rounds of initial training. For example, in some embodiments steps 302-320 are repeated for 100 rounds. In other embodiments steps 302-320 are repeated for 200 rounds. The more rounds of initial training there are, the higher the detection accuracy is expected to be. However, accurate detection is possible at even a low number of rounds. Fewer initial rounds of training performed allows for quicker detection resulting in less computation and network footprint. Generally, the greater the amount of initial training rounds, the higher the accuracy of the feature selection method.

In some embodiments, the gradients and logits often allocate a fixed amount of space in memory regardless of the information they carry. Because of this, gradients and logits not carrying contributing information take up as much space in memory as gradients and logits that do carry information. This is why it is advantageous to detect the features that do not carry information in earlier rounds of training and reduce their size. In some embodiments, the size is reduced by removing the input features that do not contribute.

The condition for reducing computation complexity is reflected in the following inequality:

$$R * Mp ( f ) > I * Mp ( f ) + {R}^{′} * Mp ( {f}^{′} )$$

According to the inequality above, R is the required number of rounds needed to achieve model saturation; Mₚ(f) is the number of model parameters, i.e., neurons, with the original input attributes, f; I is the initial number of rounds to detect non-contributing features; R′ is the number of rounds needed to achieve model saturation with the reduced number of features, f′; Mₚ(f′) is the number of model parameter with the reduced number of features.

In other embodiments, the size is reduced via high quantization. (32-bit floating points to e.g., 16-bit integer). High quantization also helps to compress the parameters at a higher compression rate.

After steps 302-328 are repeated for a predetermined number of rounds of initial training, the gradient values that were stored in the gradient memory (gradient_memory) during each round of training are averaged across all rounds. The gradient values in the gradient memory (gradient_memory) can be averaged using the following equation for all input features: np.mean(np.abs(gradient_memory)).

A gradient trajectory is then obtained 328A, 328B, 328C for every input feature. The gradient trajectory is a time series of all the input features over the predetermined number of rounds of initial training. The x axis of the gradient trajectory is the round ID. The y axis of the gradient trajectory is the mean gradient for a given round of training.

The local computing devices 302A, 302B, 302C, then detect non-contributing input features 330A, 330B, 330C by extracting the trend and periodicity of the gradient trajectory. A gradient trajectory belonging to a given input feature not having a trend is a noisy gradient trajectory. Input features with noisy gradient trajectories are typically considered non-contributing.

Significant changes to a random weight during training indicate a contributing feature. On the other hand, no significant changes to a random weight during training indicate a non-contributing feature. This difference is illustrated in the graphs below:

If a gradient trajectory belonging to a given input feature has a trend, that gradient trajectory is not a noisy gradient trajectory and the corresponding input feature is considered a contributing feature.

In some embodiments, the trend of the gradient trajectory can be identified using a pre-trained machine learning model that maps the gradient trajectory timeseries pattern to feature importance labels.

The pre-trained ML model may be trained as follows. The input X are given as the first 200 rounds of training, where the labels are obtained from the permutation importance of the features that are obtained via boosting tree model Random Forest. The permutation importances that are lower than or equal to 0 are labeled as class 0, and the values that are higher are labeled as 1. The data used for training the ML model is obtained from 4 different use cases (4 different X, y matrices). Due to the skewness, that is, having more features that are non-contributing to the model than the contributing ones, a baseline accuracy for comparison is defined. The dataset is split into training and test sets. These steps are for 20 iterations to achieve statistical significance in results. The statistical significant performance of the ML model prediction of the important features based on the gradient trajectory on the test set is obtained and presented in the below Table.

| 20 experiments | Mean | Stdev. | Min | Max |
|---|---|---|---|---|
| Baseline | 0.93 | 0.008 | 0.91 | 0.95 |
| ML predictive model | 0.97 | 0.008 | 0.94 | 0.98 |

The accuracy of the pre-trained ML model correlates to the number of rounds of gradient input. The longer the gradient vector (more rounds of gradient input), the higher the detection accuracy. However, even in earlier rounds, the accuracy is high. Below are two graphs comparing the accuracy between the pre-trained ML model and the baseline (random guess):

In other embodiments, the trend of the gradient trajectory can be identified using conventional statistical analysis. For example, in some embodiments signal decomposition can be used to identify the trend of the gradient trajectory.

Gradient trajectories belonging to features having permutation importances greater than 0 are not noisy and thus display a trend. For example, gradient trajectories belonging to features having high permutation importance are presented in the below graphs.

Gradient trajectories belonging to features having permutations importances less than zero are noisy and do not display a trend. For example, gradient trajectories belonging to features having high permutation importance are presented in the below graphs.

Once the local computing devices 302A, 302B, 302C identify the non-contributing features, the local computing devices 302A, 302B, 302C update the neuron weights 332A, 332B, 332C and remove the identified non-contributing features 334A, 334B, 334C.

FIG. 4 is a signal flow diagram illustrating signal flow according to an embodiment. The signal flow illustrated in FIG. 4 is between a central computing device 304, and a plurality of local computing devices 302A, 302B, 302C for adapting the interface (or cut) layer neuron count.

Steps 302-324 as set forth in FIG. 3, and explained above, are also present in FIG. 4.

After identifying the non-contributing neurons 324, the local computing devices 302A, 302B, 302C perform backward propagation 324A, 324B, 324C to update the neuron weights 332A, 332B, 332C.

Once the neuron weights are updated 332A, 332B, 332C, the local computing devices 302A, 302B, 302C drop the neurons at the interface layer 402A, 402B, 402C that correspond to the identified non-contributing neurons.

The local computing devices 302A, 302B, 302C transmit 404A, 404B, 404C the identified neuron indices to the central computing device 304. The central computing device 304 removes interface (or cut) layer neurons according to the identified neuron indices sent by the local computing devices 302A, 302B, 302C.The neurons removed at the interface layer are proportional to the number of features removed at the input layer. For example, if 5 out of 28 input features are dropped, the reduction of input features is 18%. If there are 64 neurons the interface neuron count is reduced according to this equation: closest_number_as_power_of_2(64-(18/100)). According to this example, if 5 out of 28 features are dropped the interface neuron count drops from 64 neurons to 8 neurons.

The local computing devices 302A, 302B, 302C send the identified neuron indices to the central computing device 304.

Once the entire method is executed, the network imprint and training time are reduced in the network as compared to the baseline scenario. The baseline scenario is a SplitNN that is trained on all features. On the other hand, the proposed scenario is a SplitNN only training on contributing features as a result of dropping the non-contributing features and the proportionate amount of cut-layer neurons. The comparison between the network footprint and the training time of the baseline scenario and the proposed scenario are depicted in the chart below:

Further, the executed method results in a drop in CPU time and total memory allocation due to the removal of non-contributing features from training. The reduction in CPU time and total memory allocation is shown in the table below:

| | | 7 contributing |
|---|---|---|
| | All 23 features | features |
| Mean CPU time at worker | 309.1 | 286.8 |
| forward pass 256 batch size | microseconds | microseconds |
| Mean CPU time at worker | 1502.4 | 1041.7 |
| forward pass 2000 batch size | microseconds | microseconds |
| Total Memory allocation | 98.242 MiB | 92.682 MiB |
| during training | | |
| Nr of parameters (nr of matrix | 23 X intermediate | 7 X intermediate |
| multiplication and gradient | layer neuron | layer neuron |
| computations) at the input | count | count |
| layer | | |

After performing the disclosed method, there is no significant reduction in validation accuracy when comparing the baseline scenario to the methods of the embodiments disclosed herein. The graph below shows the accuracy of the disclosed method according to an embodiment in which 7 features were removed from the SplitNN.

As shown in the chart above, after removing 7 input features, there is a significant reduction in training time without a significant reduction in accuracy.

In some embodiments, highly contributing features can be identified using the mean absolute gradient for each feature over the predetermined number of rounds.

The graph below shows decentralized feature importance with regard to the mean gradients (y-axis) over 200 rounds of initial training. The features with a high absolute magnitude are the highly contributing features:

In the graph above, features at indices 5, 6, and 7 are detected as being in the top 5 important features.

In some embodiments, the central computing device 304 may resume training after the neurons at the input layer and the interface cut-layer are removed.

In some embodiments, the central computing device 304 may restart training after the neurons at the input layer and the interface cut-layer are removed.

In some embodiments, the local computing device 302A, 302B, 302C can notify the central computing device 304 in case the received gradients are approaching zero so that the central computing device 304 can stop sending updates to the corresponding local computing device 302A, 302B, 302C with zero gradients. Doing such results in less communication between a local computing device 302A, 302B, 302C and the central computing device 304 further resulting in a decreased allocation of resources.

In some embodiments, the gradients corresponding to a local computing device 302A, 302B, 302C may be non-zero at a steady-state phase indicating that the weights are still being updated. In these embodiments, the local computing devices 302A, 302B, 302C should send a signal to the central computing device 304 every round to request gradient updates for the next round.

In some embodiments, the network is one or more of: a core network, a radio access network (RAN), or an open radio access network.

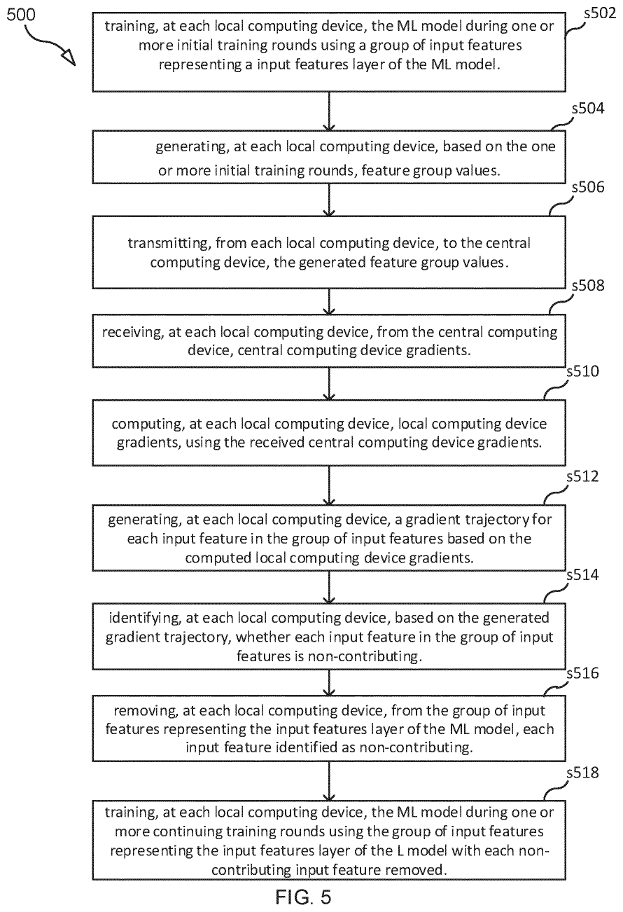

FIG. 5 is a flow chart illustrating a process according to an embodiment. Method 500 may begin with step s502.

Step s502 comprises training, at each local computing device, the ML model during one or more initial training rounds using a group of input features representing a input features layer of the ML model.

Step s504 comprises generating, at each local computing device, based on the one or more initial training rounds, feature group values.

Step s506 comprises transmitting, from each local computing device, to the central computing device, the generated feature group values.

Step s508 comprises receiving, at each local computing device, from the central computing device, central computing device gradients.

Step s510 comprises computing, at each local computing device, local computing device gradients, using the received central computing device gradients.

Step s512 comprises generating, at each local computing device, a gradient trajectory for each input feature in the group of input features based on the computed local computing device gradients.

Step s514 comprises identifying, at each local computing device, based on the generated gradient trajectory, whether each input feature in the group of input features is non-contributing.

Step s516 comprises removing, at each local computing device, from the group of input features representing the input features layer of the ML model, each input feature identified as non-contributing.

Step s518 comprises training, at each local computing device, the ML model during one or more continuing training rounds using the group of input features representing the input features layer of the L model with each non-contributing input feature removed.

In some embodiments, the local interface layer of the ML model includes a plurality of neurons and the one or more training, at each local computing device, the ML model during one or more continuing training rounds using the group of input features representing the input features layer of the ML model with each non-contributing input feature removed includes removing, at each local computing device, from the local interface layer of the ML model, one or more neurons based on the removed quantity of non-contributing input features.

In some embodiments, the steps of the method are performed until one or more conditions are satisfied: the ML model reaches convergence; a loss value computed for the ML model is less than a prespecified threshold loss value; or a performance metric reaches a prespecified performance metric value.

In some embodiments, the ML model is a split neural network (SplitNN), the input features layers and local interface layers include neurons, the local interface layers are cut layers, and the removing step includes, at each local computing device, one or more of: pruning from one or more of the input features layers or the local interface layers of the ML model, one or more neurons based on the removed quantity of non-contributing input features; or reshaping one or more of the input features layers or the local interface layers of the ML model to exclude one or more neurons based on the removed quantity of non-contributing features.

In some embodiments, the group of input features at one local computing device is orthogonal to the group of input features at the other local computing devices or non-orthogonal to the group of input features at the other local computing devices. In some embodiments, the generated feature group values are encoded. In some embodiments the generated feature group values are represented at a local interface layer of the ML model.

In some embodiments, the number of pruned neurons in the local interface layers is proportionate to the number of removed non-contributing input features. In some embodiments the local computing devices are one or more of: worker nodes, user equipment (UE), eNodeB (eNB), gNodeB (gNB), packet data network gateway (PGW), serving gateway (SGW), Internet of Thing (IoT) devices, or actuator modules. In some embodiments the central computing device is one or more of: a parameter server (PS), a master node, a driver node, or an application server.

In some embodiments, the step of identifying whether each input feature in the group of input features is non-contributing further comprises applying a pre-trained ML model to the generated gradient trajectory to determine whether a given input feature is non-contributing.

In some embodiments, the step of identifying whether each input feature in the group of input features is non-contributing further comprises: applying conventional statistical analysis to the generated gradient trajectory to determine whether a given input feature is non-contributing.

In some embodiments, the gradients corresponding to each input feature in the group of input features are computed based on loss values, said loss values being representative of errors based on differences between ground truth labels and predicted or estimated values for the labels. In some embodiments, the gradient trajectory for each input feature in the group of input features corresponds to a time series form of mean absolute gradient per input feature per layer at every round.

In some embodiments, the step of training, at each local computing device, the ML model during one or more initial training rounds includes performing forward propagation training of the ML model using the group of input features. In some embodiments the step of generating, at each local computing device, the gradient trajectory for each input feature in the group of input features based on the computed local computing device gradients includes performing backward propagation training of the ML model using the computed local computing device gradients.

In some embodiments, the group of input features corresponds to one or more of: Quality of Experience (QoE) factors or Quality of Service (QOS) parameters. In some embodiments, the network is one or more of: a core network, a radio access network (RAN), or an open radio access network (O-RAN).

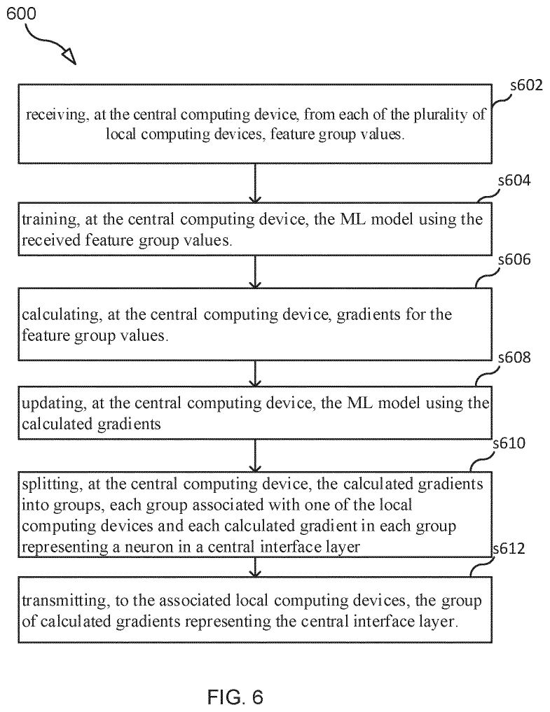

FIG. 6 is a flow chart illustrating a process according to an embodiment. Method 600 may begin with step s602.
Step s602 comprises, receiving, at the central computing device, from each of the plurality of local computing devices, feature group values.
Step s604 comprises, training, at the central computing device, the ML model using the received feature group values.
Step s606 comprises, calculating, at the central computing device, gradients for the feature group values.
Step s608 comprises, updating, at the central computing device, the ML model using the calculated gradients
Step s610 comprises, splitting, at the central computing device, the calculated gradients into groups, each group associated with one of the local computing devices and each calculated gradient in each group representing a neuron in a central interface layer
Step s612 comprises, transmitting, to the associated local computing devices, the group of calculated gradients representing the central interface layer.

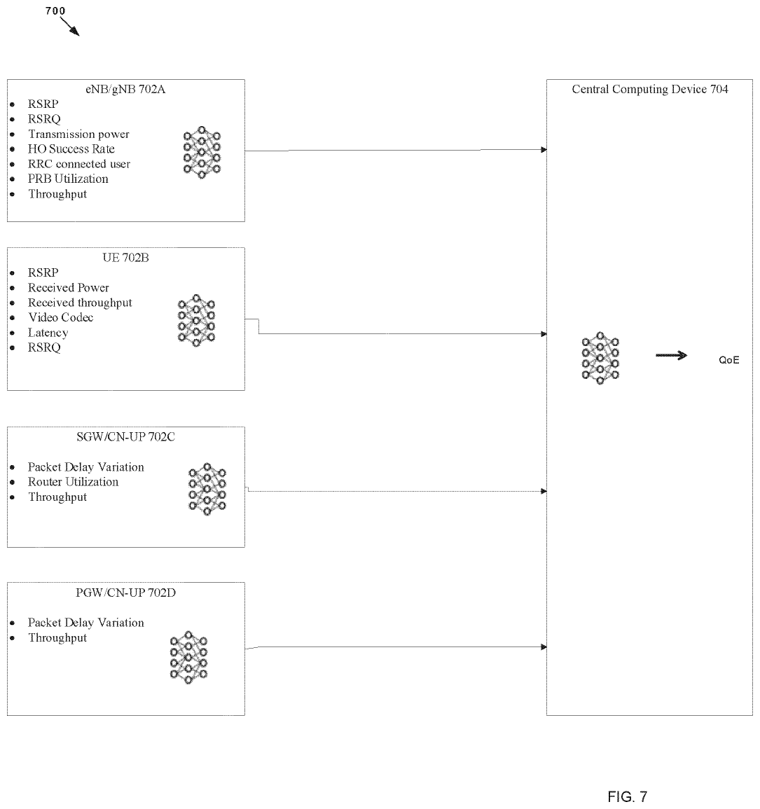

FIG. 7 is a block diagram illustrating a network including a central computing device and a plurality of local computing devices according to an embodiment. The central computing device is shown in FIG. 7 as a central computing device 704, and the plurality of local computing devices are shown in FIG. 7 as a plurality of local computing devices 702A, 702B, 702C, 702D, namely, a base station (eNB/gNB) 702A, a UE 702B, a serving gateway (SGW) 702C and a packet gateway (PGW) 702D, which act as feature groups. The base station 702A may observe features such as RSRP, RSRQ, transmission power, handover success rate, throughput, etc., while the UE 702B may observe features such as latency, received signal power, etc. Other nodes, such as the SGW 702C, may observe features such as packet delay and router utilization. Each of these network elements may be provisioned by different business segments of an overall network, such as different operators and/or service providers. For the parties to jointly train a model on the same context, the parties can either use a common identifier, such as a PDP session ID, or another session ID that can be shared and accessed across the nodes. Alternatively, a negotiated time window can be used to organize samples.

In some embodiments, the method further includes receiving, at the central computing device, updated feature group values from each of the plurality of local computing devices, and using the updated feature group values for further training of the ML model.

In some embodiments, the central interface layer includes one or more neurons and the method further includes computing, at the central computing device, an updated count of the number of neurons in the local interface layers of the ML model at the plurality of computing devices, and reshaping, at the central computing device, the central interface layer based on the computed updated count.

In some embodiments, the ML model is a split neural network (SplitNN), the ML model includes an output layer, the central interface layer and the output layer include neurons with associated weights, the central interface layer is a cut layer, and updating the ML model using the calculated gradients includes updating the associated weights of the neurons using the calculated gradients.

In some embodiments, the method further includes computing, at the central computing device, loss values at an output layer of the ML model, and the step of training, at the central computing device, the ML model using the feature group values includes concatenating the received feature group values, performing forward propagation training of the ML model using the concatenated feature group values, and performing backward propagation training of the ML model using the computed loss values.

The method and apparatus disclosed herein can, for example, be used when an actuator module that has access to partial observation does not know the consequences of its actions. For example, a partial observation and actuation in the core network, where the label is obtained in a UE or at a third party. The labels can exist on another computation node, such as a Parameter Server (PS). For example, in a medical center where the workers (patients) send their samples-then a 3^{rd} party node (a lab for example) tests their samples and labels them and sends them to the parameter server instead to avoid leaking any information to the patients.

Another application area would, for example, be security, where authorities collect sensitive observations from different environments and witnesses without sharing resulting events and consequences (ground truth).

The method and apparatus disclosed herein can, for example, be used in a cloud implementation. Split learning is a distributed learning technique in which cloud implementation is a feasible choice. Referring, for example, to FIG. 3 or FIG. 4, where the nodes are labeled as feature groups, the feature groups can be deployed at any network element that benefits from collaborative learning including RAN, core network, application server, end UE or IoT device (any terminal including vehicles and robots).

The method and apparatus disclosed herein can, for example, be used in a O-RAN implementation. In a multi-vendor setting O-RAN, in the case of a mobile UE handovers from one vendor base station to a base station at another vendor, the observations obtained at different time intervals for the same User ID (mobile) may not be collected at a centralized entity. In that case, Split Learning is a good candidate technique for building a joint model for a user. To make the training efficient and less computation heavy, it is important for the vendors to identify the non-contributing input features from different vendor datasets. For example, the method and apparatus disclosed herein could be implemented in an O-RAN to enable the rApps to select the most important contributing features so that they minimize the computation load.

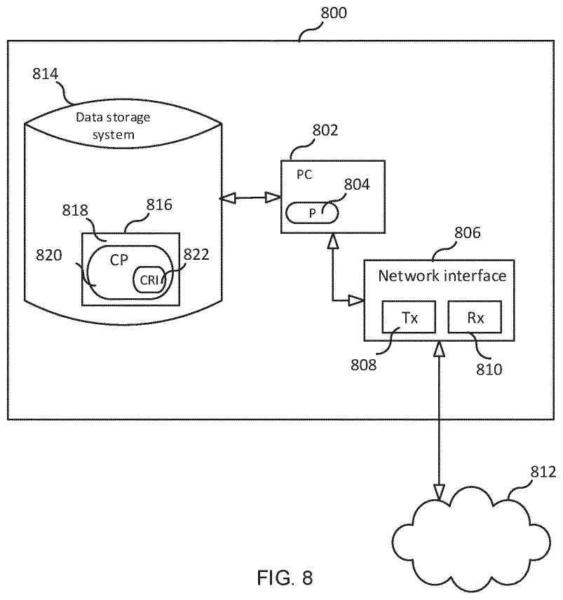

FIG. 8 is a block diagram of an apparatus 800 (e.g., a network node, connected device, and the like), according to an embodiment. As shown in FIG. 8 the apparatus may comprise: processing circuitry (PC) 802, which may include one or more processors (P) 804 (e.g., a general purpose microprocessor and/or one or more other processors, such as an application specific integrated circuit (ASIC), field-programmable gate arrays (FPGAs), and the like); a network interface 806 comprising a transmitter (Tx) 808 and a receiver (Rx) 810 for enabling the apparatus to transmit data to and receive data from other computing devices connected to a network 810 (e.g., an Internet Protocol (IP) network) to which network interface 806 is connected; and a local storage unit (a.k.a., “data storage system”) 814, which may include one or more non-volatile storage devices and/or one or more volatile storage devices. In embodiments where PC 802 includes a programmable processor, a computer program product (CPP) 816 may be provided. CPP 816 includes a computer readable medium (CRM) 818 storing a computer program (CP) 820 comprising computer readable instructions (CRI) 822. CRM 818 may be a non-transitory computer readable medium, such as, magnetic media (e.g., a hard disk), optical media, memory devices (e.g., random access memory, flash memory), and the like. In some embodiments, the CRI 822 of CP 820 is configured such that when executed by PC 802, the CRI 822 causes the apparatus 800 to perform steps described herein (e.g., steps described herein with reference to the block diagrams). In other embodiments, the apparatus may be configured to perform steps described herein without the need for code. That is, for example, PC 802 may consist merely of one or more ASICs. Hence, the features of the embodiments described herein may be implemented in hardware and/or software.

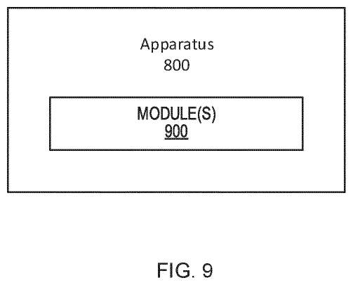

FIG. 9 is a schematic block diagram of the apparatus 800 according to an embodiment. The apparatus 800 includes one or more modules 900, each of which is implemented in software. The module(s) 900 provide the functionality of apparatus 800 described herein (e.g., steps described herein).

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer-implemented method for feature selection using a distributed machine learning (ML) model in a network comprising a plurality of local computing devices and a central computing device, the method comprising:
training, at each local computing device, the ML model during one or more initial training rounds using a group of input features representing a input features layer of the ML model;
generating, at each local computing device, based on the one or more initial training rounds, feature group values;
transmitting, from each local computing device, to the central computing device, the generated feature group values;
receiving, at each local computing device, from the central computing device, central computing device gradients;
computing, at each local computing device, local computing device gradients, using the received central computing device gradients;
generating, at each local computing device, a gradient trajectory for each input feature in the group of input features based on the computed local computing device gradients;
identifying, at each local computing device, based on the generated gradient trajectory, whether each input feature in the group of input features is non-contributing;
removing, at each local computing device, from the group of input features representing the input features layer of the ML model, each input feature identified as non-contributing; and
training, at each local computing device, the ML model during one or more continuing training rounds using the group of input features representing the input features layer of the ML model with each non-contributing input feature removed.

2. The method according to claim 1, wherein the local interface layer of the ML model includes a plurality of neurons and the one or more training, at each local computing device, the ML model during one or more continuing training rounds using the group of input features representing the input features layer of the ML model with each non-contributing input feature removed includes:
removing, at each local computing device, from the local interface layer of the ML model, one or more neurons based on the removed quantity of non-contributing input features.

3. The method according to claim 1, wherein the steps of the method are performed until one or more conditions are satisfied:
the ML model reaches convergence;
a loss value computed for the ML model is less than a prespecified threshold loss value; or
a performance metric reaches a prespecified performance metric value.

4. The method according to claim 1, wherein the ML model is a split neural network (SplitNN), the input features layers and local interface layers include neurons, the local interface layers are cut layers, and the removing step includes, at each local computing device, one or more of:
pruning from one or more of the input features layers or the local interface layers of the ML model, one or more neurons based on the removed quantity of non-contributing input features; or
reshaping one or more of the input features layers or the local interface layers of the ML model to exclude one or more neurons based on the removed quantity of non-contributing features.

5. The method according to claim 1, wherein the group of input features at one local computing device is orthogonal to the group of input features at the other local computing devices or non-orthogonal to the group of input features at the other local computing devices

6.-18. (canceled)

19. A computer-implemented method for feature selection using a distributed machine learning (ML) model in a network comprising a plurality of local computing devices and a central computing device, the method comprising:
receiving, at the central computing device, from each of the plurality of local computing devices, feature group values;
training, at the central computing device, the ML model using the received feature group values;
calculating, at the central computing device, gradients for the feature group values;
updating, at the central computing device, the ML model using the calculated gradients;
splitting, at the central computing device, the calculated gradients into groups, each group associated with one of the local computing devices and each calculated gradient in each group representing a neuron in a central interface layer; and
transmitting, to the associated local computing devices, the group of calculated gradients representing the central interface layer.

20. The method according to claim 19, further comprising:
receiving, at the central computing device, updated feature group values from each of the plurality of local computing devices; and
using the updated feature group values for further training of the ML model.

21. The method according to claim 20, wherein the central interface layer includes one or more neurons and the method further comprising:
computing, at the central computing device, an updated count of the number of neurons in the local interface layers of the ML model at the plurality of computing devices; and
reshaping, at the central computing device, the central interface layer based on the computed updated count.

22. The method according to claim 19, wherein the ML model is a split neural network (SplitNN), the ML model includes an output layer, the central interface layer and the output layer include neurons with associated weights, the central interface layer is a cut layer, and updating the ML model using the calculated gradients includes updating the associated weights of the neurons using the calculated gradients.

23. The method according to claim 19, further comprising:
computing, at the central computing device, loss values at an output layer of the ML model; and
wherein the step of training, at the central computing device, the ML model using the feature group values includes:
concatenating the received feature group values;
performing forward propagation training of the ML model using the concatenated feature group values; and
performing backward propagation training of the ML model using the computed loss values.

24. A local computing device for feature selection using a distributed machine learning (ML) model in a network comprising a plurality of local computing devices and a central computing device, comprising:
a memory; and
a processor coupled to the memory, wherein the processor is configured to:
train, at each local computing device, the ML model during one or more initial training rounds using a group of input features representing a input features layer of the ML model;
generate, at each local computing device, based on the one or more initial training rounds, feature group values;
transmit, from each local computing device, to the central computing device, the generated feature group values;
receive, at each local computing device, from the central computing device, central computing device gradients;
compute, at each local computing device, local computing device gradients, using the received central computing device gradients;
generate, at each local computing device, a gradient trajectory for each input feature in the group of input features based on the computed local computing device gradients;
identify, at each local computing device, based on the generated gradient trajectory, whether each input feature in the group of input features is non-contributing;
remove, at each local computing device, from the group of input features representing the input features layer of the ML model, each input feature identified as non-contributing; and
train, at each local computing device, the ML model during one or more continuing training rounds using the group of input features representing the input features layer of the L model with each non-contributing input feature removed.

25.-31. (canceled)

32. The local computing device according to claim 24, wherein the local computing devices are one or more of: worker nodes, user equipment (UE), eNodeB (eNB), gNodeB (gNB), packet data network gateway (PGW), serving gateway (SGW), Internet of Thing (IoT) devices, or actuator modules.

33. The local computing device according to claim 24, wherein the central computing device is one or more of: a parameter server (PS), a master node, a driver node, or an application server.

34.-39. (canceled)

40. The local computing device according to claim 24, wherein the group of input features corresponds to one or more of: Quality of Experience (QoE) factors or Quality of Service (QOS) parameters.

41. The local computing device according to claim 24, wherein the network is one or more of: a core network, a radio access network (RAN), or an open radio access network (O-RAN).

42. A central computing device for feature selection using a distributed machine learning (ML) model in a network comprising a plurality of local computing devices, comprising:
a memory; and
a processor coupled to the memory, wherein the processor is configured to:
receive, at the central computing device, from each of the plurality of local computing devices, feature group values;
train, at the central computing device, the ML model using the received feature group values;
calculate, at the central computing device, gradients for the feature group values;
update, at the central computing device, the ML model using the calculated gradients;
split, at the central computing device, the calculated gradients into groups, each group associated with one of the local computing devices and each calculated gradient in each group representing a neuron in a central interface layer; and
transmit, to the associated local computing devices, the group of calculated gradients representing the central interface layer.

43. The central computing device according to claim 42, wherein the processor is further configured to:
receive, at the central computing device, updated feature group values from each of the plurality of local computing devices; and
use the updated feature group values for further training of the ML model.

44. The central computing device according to claim 43, wherein the central interface layer includes one or more neurons and the processor is further configured to:
compute, at the central computing device, an updated count of the number of neurons in the local interface layers of the ML model at the plurality of computing devices; and
reshape, at the central computing device, the central interface layer based on the computed updated count.

45. The central computing device according to claim 42, wherein the ML model is a split neural network (SplitNN), the ML model includes an output layer, the central interface layer and the output layer include neurons with associated weights, the central interface layer is a cut layer, and updating the ML model using the calculated gradients includes updating the associated weights of the neurons using the calculated gradients.

46. The central computing device according to claim 42, wherein the processor is further configured to:
compute, at the central computing device, loss values at an output layer of the ML model; and
wherein the training, at the central computing device, the ML model using the feature group values includes:
concatenating the received feature group values;
performing forward propagation training of the ML model using the concatenated feature group values; and
performing backward propagation training of the ML model using the computed loss values.

47.-49. (canceled)
